(19) United States
(12) Patent Application Publication
(10) Pub. No.: US 2012/0196978 A1
(43) Pub. Date: Aug. 2, 2012

(54) Polyester Heat Storage Material and Preparation Method Thereof

(75) Inventors: Yin-Hsi Lin, New Taipei City (TW); Chi-Shu Wei, New Taipei City (TW); Cheng-Chu Lin, New Taipei City (TW); Ming-Chih Kuo, New Taipei City (TW); Sheng-Shan Chang, New Taipei City (TW)

(73) Assignee: TAIWAN TEXTILE RESEARCH INSTITUTE, New Taipei City (TW)

(21) Appl. No.: 13/165,006

(22) Filed: Jun. 21, 2011

(30) Foreign Application Priority Data
Jan. 31, 2011 (TW) 100103667

(51) Int. Cl. C08L 67/02; B29C 47/00; C08G 63/672

(52) U.S. Cl. 524/604; 528/301; 528/293; 525/539; 264/176.1

(57) ABSTRACT

A polyester heat storage material and a preparation method thereof are disclosed. The repeating unit of the polyester's main chain comprises a diacid fragment and a polyalkylene glycol fragment. The method for preparing the polyester heat storage material includes melting diacid anhydride and polyalkylene glycol and conducting the polycondensation reaction.

### RELATED APPLICATIONS

This application claims priority to Taiwan Application Serial Number 100103667, filed Jan. 31, 2011, which is herein incorporated by reference.

### BACKGROUND

1. Field of Invention

The present invention relates to heat storage material. More particularly, the present invention relates to polyester heat storage material.

2. Description of Related Art

Polyester heat storage material is a kind of ambient heat regulating material. The feature of this kind of materials posses the ability to absorb/release energy at a specific temperature ranges. Heat storage materials can absorb heat as the ambient temperature rising, and they can release the previous heat as the ambient temperature falling. Since the properties of the heat storage materials were investigated, heat storage materials have been widely exploited on various types of garments and clothing fabrics and textile for temperature regulation.

In recent years, the conventional heat storage material used in clothing textile are short chain hydrocarbons, and the most common way to utilize those short chain hydrocarbons is by incorporating them into the microcapsules and then applied the microcapsules onto the clothing materials. However, the short chain hydrocarbons are easily melting and cracking at high temperature, they are not suitable for the conventional textile manufacturing processes, such as melt spinning and melt blowing, at high-temperature. In addition, it has been known that the short chain hydrocarbons have the lower viscosity at melting state, short chain hydrocarbons might come out from the microcapsules as it absorbing heat. The textile surfaces with the microcapsules heat storage materials give the bad and uncomfortable touching feeling to the user. Therefore, the applications of the conventional heat storage materials are limited.

### SUMMARY

A polyester heat storage material is provided. According to the embodiments of the present invention, the repeating unit of polyester heat storage material comprises a diacid fragment and a polyalkylene glycol fragment. The diacid fragment is maleic acid, maleic anhydride, succinate acid or succinate anhydride, and a polyalkylene glycol fragment is polyethylene glycol or polybutylene glycol.

According to one embodiment, the heat absorption temperature of the polyester heat storage material is 15-40° C., maximum thermal weight loss temperature is at least higher than 350° C., and the latent heat of the polyester heat storage material is 50-120 J/g.

The polyester heat storage material preparation includes steps below. The reactant composition is heated into the melting state to form the molten solution, where the reactant composition is polyalkylene glycol and diacid anhydride, the molar ratio of polyalkylene glycol to diacid anhydride is 0.95-1. Diacid anhydride could be maleic anhydride or succinic anhydride, and polyalkylene glycol could be polyethylene glycol or polybutylene glycol. An acid is added into the molten solution to start the polycondensation reaction. After accomplishing the polycondensation reaction, alkoxide is added to neutralize the molten solution, where alkoxide has the same molar equivalent number as the acid.

According to one embodiment, where the alkoxide is sodium methoxide or sodium ethoxide.

According to one embodiment, where the acid is sulfuric acid, the applied acid quantity is 1-4 wt % of the diacid anhydride, and the heating temperature is 130-140° C.

According to another embodiment, the solvent is added to dissolve the reactant composition before heating the reactant composition, and the acid is sulfuric acid, the amount of the applied acid quantity is 5-10 wt % of diacid anhydride

According to the embodiments, a polyester heat storage masterbatch/fibers comprise a polyester heat storage material and a melt spinning polymer, where the content of the polyester heat storage material is less than or equal to 16 wt %, and the melt spinning polymer is nylon, polyester or polypropylene.

The polyester heat storage materials present better thermal stability and high temperature spinning ability, enabling the high temperature melt spinning process, according to the embodiments of the present invention. The heat storage materials presented in this invention can be directly applied in melt spinning process to form fabrics or textile, and can further widely be applied in clothing and garments. Therefore, the presented polyester heat storage material solve the issues of the conventional heat storage materials in terms of uncomfortable touch feeling and low melting temperature of the hydrocarbon microcapsules.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 shows a flowchart of a method of preparing polyester heat storage material according to one embodiment of present invention.

FIG. 2 shows a flowchart of another method of preparing polyester heat storage material according to one embodiment of present invention.

FIG. 3 shows a flowchart of a method of preparing heat storage fibers according to one embodiment of present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

### Polyester Heat Storage Material

According to one embodiment of the present invention, the repeating unit of the main chain of the polyester heat storage material as the forgoing mentioned includes a diacid fragment and a polyalkylene glycol fragment. The source of the diacid fragment could be maleic acid, maleic anhydride, succinic acid or succinic anhydride, and the source of the polyalkylene glycol fragment could be polyethylene glycol or polybutylene glycol.

According to one example, the above polyester heat storage material has latent heat absorbing temperature (melting point) at 15-45° C., latent heat 50-120 J/g and maximum thermal weight loss temperature at least higher than 350° C.

### Preparation Method of Polyester Heat Storage Material

There are two methods for preparing polyester heat storage material. One is to directly heating the reactant composition without adding solvent. The other one is to dissolve the reactant composition with the solvent before conducting the polycondensation reaction.

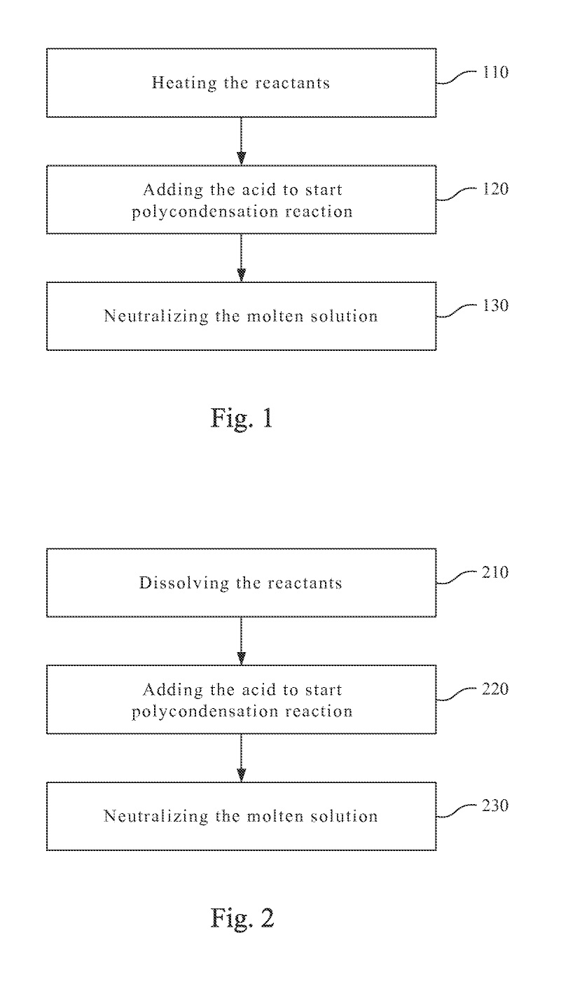

FIG. 1 shows the flowchart of a method for preparing the polyester heat storage material according to one embodiment of the present invention. The preparation method shown in FIG. 1 is the method without adding any solvent.

In step 110 of FIG. 1, the reactant composition is directly heated into the melting state without adding any solvent, and the molten solution is formed. The reactant composition includes diacid anhydride and polyalkylene glycol, where diacid anhydride could be maleic anhydride or succinic anhydride, and polyalkylene glycol could be polyethylene glycol or polybutylene glycol. The molar ratio of polyalkylene glycol to anhydride is 0.95-1.

Since the reactant composition are heated and melted without any solvent in step 110, the temperature of the heating process is based on the melting point of the reactant composition. Generally, the melting point of diacid anhydride is higher than the melting point of polyalkylene glycol, and thus the heating temperature is at least higher than the melting point of diacid anhydride in this method. For example, the melting point of maleic anhydride is 52.8° C., and the melting point of succinic anhydride is 119-120° C.

Following step 120, an acid is added in the molten solution for the polycondensation reaction. The acid provided herein is to induce the ring-opening process of the diacid anhydride and to start the polycondensation reaction. The polyester heat storage material is obtained after accomplishing the polycondensation reaction. The required amount of the acid is based on the employed diacid anhydride quantity of the previous step. For example, the acid to the diacid anhydride is 1-4 wt % when the acid is sulfuric acid, and the heating temperature is at 130-140° C.

According to one embodiment, a distillation process can also be performed simultaneously while conducting the polycondensation reaction. Water, generated from the polycondensation reaction in step 120, can be removed during the distillation process, so as to eliminate the decreasing yield of the polyester heat storage material. The device and the method of the distillation process could be any kind of distillation device and method.

Finally, in step 130, an alkoxide is added to neutralize the acid after the molten solution cool down. The amount of the applied alkoxide is based on the molar equivalent number of the acid applied in the previous step. For example, the employed amount of alkoxide has the similar molar equivalent number to the acid. The alkoxide used herein could be sodium methoxide or sodium ethoxide.

FIG. 2 shows the flowchart of a method for preparing polyester heat storage material based on another embodiment of the present invention. In FIG. 2, the solvent is applied before the polycondensation reaction to dissolve the reactant composition. In step 210, the reactant composition is dissolved by mixing and heating the reactant composition and the solvent. The reactant solution is obtained after the reactant composition is dissolved. The reactant composition is as same as the composition which employed in step 110, and thus the detail descriptions of the reactant composition is skipped here for the reason of clarity.

The basic properties of the solvent are that can dissolve the reactant composition, but do not react with the reactant composition. In addition, in order to azeotropically distillate water during the polycondensation reaction, the solvent with the azeotropic point to water is chosen in this method. The solvent could be toluene or benzene. For example, the reactant composition and toluene could both be mixed and heated to the constant boiling point (100-110° C.) to azeotropically distillate water.

Except the different quantity of the acid is applied in the following steps, steps 210 and 230 are similar to steps 120 and 130 respectively, and thus the detail description are skipped for the reason of clarity. In step 220, the required amount of the acid is based on the diacid anhydride quantity applied in the previous step. For example, the acid to anhydride is 5-10 wt % of the diacid anhydride when the applied acid is sulfuric acid.

### Preparation Method for Heat Storage Fibers

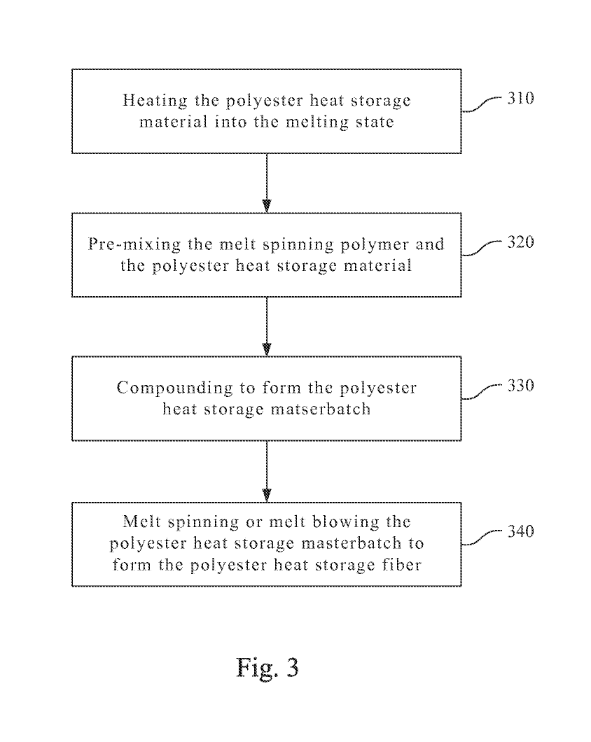

FIG. 3 shows the flowchart of a method for preparing heat storage fibers according to one embodiment of the present invention.

In FIG. 3, the method of preparing heat storage fibers includes heating the polyester heat storage material into the melting state (step 310), pre-mixing the melt spinning polymer and the polyester heat storage material (step 320), compounding and granulate to form heat storage masterbatch (step 330) and melt spinning or melt blowing the heat storage masterbatch to obtain a heat storage fiber or a nonwoven fabric (step 340).

In step 310, the polyester heat storage material produced from the preparation method above is heated into the melting state to form the molten polyester heat storage material. The purpose of this step is to make the afterwards pre-mixing step 320 easier.

In step 320, the molten polyester heat storage material and the melt spinning polymer are pre-mixed together, allowing the molten polyester heat storage material to be uniformly dispersed in the melt spinning polymer. Since high viscosity of the molten polyester heat storage material is investigated, the homogenous blend of the molten polyester heat storage material and the melt spinning polymer is not easily to achieve. The poor dispersive heat storage masterbatch would easily to obtain if directly compounding and granulating the molten polyester heat storage material and the melt spinning polymer. Thus, step 310 and step 320 provided herein are to achieve the homogenous blend of the heat storage masterbatch in this method. According to one embodiment of the present invention, the ratio of the polyester heat storage material to the melt spinning polymer is less than 16 wt %.

Besides, the melt spinning polymer could be any material that used in the melting spinning process. The melt spinning polymers include, but not limited to, polyester, such as polyethylene terephthalate, polyproylene terephthalate, or polybuthylene terephthalate; polyamide, such as nylon 6 or nylon 66; and polyolefin, such as polypropylene; or polyvinyl chloride.

In step 330, the mixed product from step 320 is compounded and granulated to form the heat storage masterbatch. The compounding process is enable the melt spinning polymer and the polyester heat storage material to be homogenously mixed with the shear stress provided from the compounding machine. The compounding conditions play the role in the two materials dispersion, such as the compounding temperature. According to the embodiments, the compounding temperature of the polyester heat storage material and the melt spinning polymers are 200-400° C. in this method.

The compounding machine could be any kind of compounding machine that can achieve a homogenous blend of polymers. For example, the compounding machine could be a single screw or a twin-screw compounding machine.

Finally, in step 340, the heat storage masterbatch generated from the previous step are melt spun or melt blown, and heat storage fibers or heat storage nonwoven fabrics were formed.

The various heat storage fibers or nonwoven fabrics could be prepared by following the methods provided above, and those fibers or nonwoven fabrics can be further applied in a variety of products. For example, heat storage fibers could be used in clothing textile, bedding textile and furniture products.

### Embodiment 1: Different Molecular Weight of Polyalkylene Glycol are Applied to Form Polyester Heat Storage Materials

In Embodiment 1, the effectiveness of the polyalkylene glycol molecular weight (MW) on polyester heat storage materials are examined.

The amounts of reactant composition added in the process are listed in Table 1. In Table 1, Examples 1 and 3 were prepared based on the preparation method of FIG. 2, where the solvent was toluene, whereas Example 2 was prepared based on the preparation method of FIG. 1 without adding any solvent. The reaction conditions are presented above, and the results are listed in Table 2.

PTMG presented in Table 1 and Table 2 stands for polytetramethylene glycol, wherein number of PTMG1000, PTMG2000, PTMG3000 represent as PTMG molecular weight respectively. MA presented in Table 1 and Table 2 stands for maleic anhydride.

TABLE 1
the amount of the reation composition and collected water

| | | Polyalkylene | Anhydride | Toluene | Sulfuric | Collected | MeONa |
|---|---|---|---|---|---|---|---|
| Example | | glycol (g) | (g) | (g) | acid (g) | water (g) | (g) |
| 1 | PTMG1000-MA | 484 | 50 | 175 | 3.7 | 9.18 | 4.5 |
| 2 | PTMG2000-MA | 194 | 10 | 0 | 0.4 | 1.83 | 1.12 |
| 3 | PTMG3000-MA | 145 | 5 | 150 | 0.5 | 0.92 | 0.56 |

Table 2, the results of polyester heat storage materials with different polyalkylene glycol molecular weight applied

| | | Polyalkylene | | | Maximum |
|---|---|---|---|---|---|
| | | glycol/ | | Latent | weight loss |
| | | anhydride | Melting point | heat | temperature |
| Example | | (Molar ratio) | (° C.)¹ | (J/g)¹ | (° C.)² |
| 1 | PTMG1000-MA | 0.95 | 19.15 | 60.01 | 434 |
| 2 | PTMG2000-MA | 0.95 | 24.7 | 70.78 | 423 |
| 3 | PTMG3000-MA | 0.95 | 35.6 | 83.06 | 434 |

¹measured by differential scanning calorimeter (DSC)
²measured by thermal gravity analysis (TGA)

In this embodiment, the latent heat of the polyester heat storage materials are near 60-83 J/g according to the results in Table 2, which present the relative larger latent heat thermal energy storage per unit mass. The thermal weight loss temperature of the polyester heat storage materials are all above 423° C., which represent the polyester heat storage materials could stand the high temperature melt spinning process without polymer structure cracking.

Besides, as the larger molecular weights of PTMG were applied, the higher enthalpies and melting points of the polyester heat storage material were obtained resulting from the polyalkylene glycol monomer is mainly responsible for heat storage. However, with the increasing PTMG molecular weight, the maximum thermal weight loss temperatures of the polyester heat storage materials still remain the same.

### Embodiment 2: Different Kind of Diacid Anhydride are Applied to Form Polyester Heat Storage Materials

In embodiment 2, the effectiveness of the different diacid anhydride on polyester heat storage materials are examined. In Table 3, Examples 4, 5 and 6 were prepared based on the preparation method of FIG. 2, where toluene as the solvent. The reaction conditions are presented above, and the results are listed in Table 4. PEG presented in Table 3 and Table 4 stands for polyethylene glycol, wherein number of PEG600, PEG1000, PEG1500 represent as PEG molecular weight respectively. MA presented in Table 1 and Table 2 stands for maleic anhydride, SA stands for succinic anhydride.

TABLE 3
the amount of the reaction composition and collection of water

| | | Polyalkylene | Anhydride | Toluene | Sulfuric | Collected | |
|---|---|---|---|---|---|---|---|
| Example | | glycol (g) | (g) | (g) | acid (g) | water (g) | MeONa (g) |
| 4 | PEG600-MA | 58 | 10 | 125 | 1 | 1.83 | 1.12 |
| 5 | PEG1000-SA | 95 | 10 | 125 | 1 | 1.83 | 1.12 |
| 6 | PEG1500-SA | 142 | 10 | 125 | 1 | 1.83 | 1.12 |

Table 4, the results of the polyester heat storage materials with different diacid anhydride applied

| | | Polyalkylene | | | Maximum |
|---|---|---|---|---|---|
| | | glycol/ | | Latent | weight loss |
| | | anhydride | Melting point | heat | temperature |
| Example | | (Molar ratio) | (° C.)¹ | (J/g)¹ | (° C.)² |
| 4 | PEG600-MA | 0.95 | 24.91 | 55.88 | 393 |
| 5 | PEG1000-SA | 1 | 35.49 | 104.6 | 370 |
| 6 | PEG1500-SA | 0.95 | 40.09 | 112.9 | 375 |

¹measured by differential scanning calorimetry (DSC)
²measured by thermal gravity analysis (TGA)

In this embodiment, the latent heat of the polyester heat storage materials are near 55-113 J/g according the results in Table 4, which present the relative larger latent heat thermal energy storage per unit mass. The thermal weight loss temperature of the polyester heat storage materials are all above 370° C., which represent the polyester heat storage materials could stand the high temperature melt spinning process without polymer structure cracking.

Besides, as the larger molecular weights of polyethylene glycol (PEG) were applied, the higher latent heat and melting points of the polyester heat storage material were obtained. The maximum thermal weight loss temperatures of Examples 4-6 are dissimilar, as the different kinds of diacid anhydride, MA and SA, were applied in the process. Apparently, maleic anhydride (MA), Examples 4, provides the better thermal resistance property to the polyester heat storage materials. Maximum thermal weight loss temperature of Example 4 shows 20° C. higher than Examples 5-6.

### Embodiment 3: Different PTMG2000-MA are Applied to Form Nylon Fiber

In Embodiment 3, the effectiveness of PTMG2000-MA (Example 2) content on heat storage nylon fibers are examined. The mixing ratio of PTMG2000-MA to nylon 6 are 4, 8, 12 wt % respectively. The average molecular weight of PTMG2000-MA is 25764, which correspond to 12-13 repeating units of PTMG2000-MA in one polymer. The mixing temperature of twin-screw compounding machine is at 220-240° C., the temperature of the melt spinning process is at 220-250° C. The results are listed in Table 5.

TABLE 5
the results of nylon fibers with different PTMG2000-MA content
applied

| | | Melting | Latent | maximum thermal |
|---|---|---|---|---|
| PTMG2000-MA | | Point | heat | weight loss |
| (wt %) | Stage | (° C.)¹ | (J/g)¹ | temperature (° C.)² |
| 4 | masterbatch | 15.40 | 0.91 | 444.92 |
| | fiber | 16.07 | 0.76 | 440.66 |
| 8 | masterbatch | 19.86 | 2.77 | 443.41 |
| | fiber | 19.96 | 2.57 | 441.90 |
| 12 | masterbatch | 15.94 | 5.36 | 445.68 |
| | fiber | 16.89 | 4.18 | 445.68 |

¹measured by differential scanning calorimeter (DSC)
²measured by thermal gravity analysis (TGA)

According to the results listed in Table 5, latent heat of the heat storage nylon fibers are near 0.7-5 J/g, and maximum thermal weight loss temperatures are all above 440° C. Besides, as increasing PTMG2000-MA content in the process, the higher latent heat of heat storage masterbatch/fibers were obtained, the highest latent heat of the heat storage nylon fibers is up to 5.36 J/g. The PTMG2000-MA content has less influence on latent heat absorbing temperature (melting point) and maximum thermal weight loss temperature.

According to one embodiment of the present invention, the polyester heat storage material to nylon 6 should be less or equal to 16%, and thus the polyester heat storage material can be uniformly mixed with nylon 6. On the other hand, if the applied polyester heat storage material to nylon ratio is over 16%, the non-continuous phase of heat storage nylon fibers would obtain during the spinning process. In addition, the heat storage fibers could also be made into core-sheath structure fibers for various applications.

The embodiments of the present invention provide the polyester heat storage material, which have the better thermal stability and higher temperature tolerance for doing the high temperature melt spinning process comparing to the conventional heat storage materials. The heat storage materials presented in this invention can directly applied in melt spinning process to form fabrics or textile, and can further widely be applied in clothing or other products. Therefore, the presented polyester heat storage material solve the issues of the conventional heat storage materials in terms of uncomfortable touch feeling and low thermal stability of the hydrocarbon microcapsules.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A polyester heat storage material, the repeating unit of the heat storage material comprising:
a diacid fragment, the diacid fragment is maleic acid, maleic anhydride, succinic acid or succinic anhydride; and
a polyalkylene glycol fragment, the polyalkylene glycol fragment is polyethylene glycol or polybutylene glycol.

2. The polyester heat storage material of claim 1, wherein the latent heat absorption temperature of the polyester heat storage material is 15-40° C.

3. The polyester heat storage material of claim 1, wherein the latent heat of the polyester heat storage material is 50-120 J/g.

4. The polyester heat storage material of claim 1, wherein the maximum thermal weight loss temperature of the polyester heat storage material is at least higher than 350° C.

5. A method for preparation a polyester heat storage material, the method comprising:
heating a reactant composition into melting state to form a molten solution, the reactant composition comprises 0.95-1 molar ratio of a polyalkylene glycol to a diacid anhydride, wherein the diacid anhydride is maleic anhydride or succinic anhydride, and the polyalkylene glycol is polyethylene glycol or polybutylene glycol;
adding an acid into the molten solution, to start polycondensation reaction; and
adding an alkoxide to neutralize the molten solution, wherein the molar equivalent number of the alkoxide is the same as the acid.

6. The preparation method of claim 5, wherein the acid is sulfuric acid, the quantity of the acid is 1-10 wt % of the diacid anhydride, and the reaction temperature is 130-140° C.

7. The preparation method of claim 5, further comprising distilling the molten solution to remove water while performing polycondensation reaction.

8. The preparation method of claim 5, further comprising adding solvent to dissolve the reactant composition before heating the reactant composition.

9. The preparation method of claim 8, wherein the acid is sulfuric acid, the quantity of the acid is 5-10 wt % of the diacid anhydride.

10. The preparation method of claim 5, wherein the alkoxide is sodium methoxide or sodium ethoxide.

11. The preparation method of claim 5, wherein the latent heat absorption temperature of the polyester heat storage material is 15-40° C.

12. The preparation method of claim 5, wherein the latent heat of the polyester heat storage material is 50-120 J/g.

13. The preparation method of 5, wherein the maximum thermal weight loss temperature of the polyester heat storage material is at least higher than 350° C.

14. The preparation method of 5, further comprising compounding the polyester heat storage material and a melt spinning polymer to from a polyester heat storage masterbatch, wherein the polyester heat storage material is less than 16 wt %, and the melt spinning polymer is nylon, polyester, or polypropylene.

15. The preparation method of 5, further comprising melt spinning or melt blowing the polyester the heat storage material to from a polyester heat storage fiber.

16. A polyester heat storage masterbatch, comprising:
a polyester heat storage material of claim 1, the content of the a polyester heat storage material is less than 16 wt %; and
a melt spinning polymer, the melt spinning polymer is nylon, polyester or polypropylene.

17. The polyester heat storage masterbatch of claim 16, wherein the content of the polyester heat storage material is less than 12 wt %.

18. A polyester heat storage fibers, the composition of the fibers comprising:
a polyester heat storage material of claim 1, the content of the polyester heat storage material is less than 16 wt %; and
a melt spinning polymer, the melt spinning polymer is nylon, polyester or polypropylene.

19. The polyester heat storage fibers of claim 18, wherein the content of the polyester heat storage material is less than 12 wt %.
